(19) United States
(12) Patent Application Publication
(10) Pub. No.: US 2025/0333605 A1
(43) Pub. Date: Oct. 30, 2025

(54) MINERAL SUSPENSION STABILIZED BY GRINDING

(71) Applicant: COATEX, Genay (FR)

(72) Inventors: Christian JACQUEMET, Lyon (FR); Jacques MONGOIN, Quincieux (FR); Laurie PARRENIN, Villeneuve (FR); Benoit MAGNY, Fontaines Saint Martin (FR); Jean-Marc SUAU, Lucenay (FR); Morgane LE NEINDRE, Curis-au-Mont-d’Or (FR)

(73) Assignee: COATEX, Genay (FR)

(21) Appl. No.: 18/703,795

(22) PCT Filed: Nov. 24, 2022
(86) PCT No.: PCT/FR2022/000121

§ 371 Date: Apr. 23, 2024

(30) Foreign Application Priority Data
Nov. 25, 2021 (FR) FR2112488

(51) Int. Cl. C09C 3/10; D21H 17/00; D21H 19/36

(52) U.S. Cl. CPC C09C 3/10; D21H 17/74; D21H 19/36; C01P 2004/61; C01P 2004/62; C01P 2006/22

(57) ABSTRACT

An aqueous suspension of a mineral material, for example calcium carbonate, may be prepared by wet grinding in the presence of an aqueous dispersion of (meth)acrylic polymer neutralized by a combination of at least one monovalent ion and at least one divalent ion. Such an agent may be used for facilitating grinding and such a mineral suspension may be used for preparing a mass filler for the preparation of paper, for preparing a paper coating slip, or for preparing a coating composition.

The invention provides an aqueous suspension of a mineral material, for example calcium carbonate, which is prepared by wet grinding in the presence of an aqueous dispersion of (meth)acrylic polymer neutralised by means of a combination of at least one monovalent ion and of at least one divalent ion. The invention also relates to a grinding aid agent as well as to the use of this mineral suspension to prepare a mass filler for the preparation of paper or for its use in the preparation of a paper coating colour or in the preparation of a coating composition.

There are known methods for preparing suspensions of mineral material. In particular, there are known methods that use grinding aid agents, in particular to control the rheology of the suspension when preparing or storing it.

Document WO 2007077484 describes the preparation, in the presence of a polyacrylate, of an aqueous suspension comprising ground calcium carbonate and precipitated calcium carbonate. Document WO 2008010055 describes the dispersion in water of a mineral material in the presence of a (meth)acrylic-maleic copolymer.

In general, the methods of grinding mineral material must be effective and make it possible to control the particle size distribution of the particles obtained. Furthermore, the methods for grinding mineral material must have a high efficacy in terms of grinding time for a particular particle size distribution for a defined amount of mineral material. In fact, when preparing a defined amount of mineral particles of a particular particle size distribution, reducing the operating time of the grinding equipment improves the overall yield of the grinding method.

Likewise, it is important to have methods for grinding mineral material that make it possible to prepare aqueous suspensions of particles of mineral material that are stable not only shortly after preparation, but also several hours or days later. Viscosity drift phenomena must be controlled because they can lead to gelation of the prepared suspensions which would make handling difficult or impossible. Likewise, particle settling phenomena must be avoided or substantially slowed.

In addition to controlling the stability, it is also essential to control the viscosity of the aqueous suspensions of ground particles of mineral material.

It is also important to be able to prepare aqueous suspensions of particles of mineral material with a high solids content. A high solids content of these aqueous suspensions of particles of mineral material makes it possible in particular to increase the productivity of the methods that use these suspensions.

Moreover, it should be possible to prepare grinding aid agents in the absence of any compounds that could be considered harmful from an environmental standpoint or in the absence of any compounds that are restricted for use by regulatory provisions. In particular, preparing these agents in the absence of any compound comprising phosphorus should be preferred, especially the absence of any phosphorus in oxidation state I, III or V.

Furthermore, during papermaking, aqueous mineral filler compositions are used to provide a mineral filler within the pulp comprising water and fibres of vegetable origin, in particular fibres of cellulosic material. Within these compositions, the mineral filler is in the form of particles. The use of such mineral fillers makes it possible in particular to improve the physical properties of the paper, in particular to improve its optical properties, or to reduce the relative amount of cellulosic material in relation to the amount of mineral filler. Improving the efficacy of papermaking methods is also made possible through the use of these mineral fillers. The formation of flocs of mineral filler particles or of fibres that impair the quality of the paper must also be limited. Improving the compatibility of the various compounds used in the preparation of paper should also be sought.

Thus, although there are methods for wet grinding mineral material using polymers as grinding aid agents, the methods in the prior art do not always make it possible to provide a satisfactory solution to the problems encountered with the aqueous mineral suspensions obtained. There is therefore a need for improved aqueous suspensions of mineral material. The invention makes it possible to provide a solution to all or part of the problems of the suspensions in the prior art.

Thus, the invention provides an aqueous suspension S of mineral particles prepared by wet grinding at least one mineral material M in the presence of an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV (sulphur IV or S IV), and completely or partially neutralised solely by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV.

Preferably for suspension S according to the invention, the particles of dispersed material M have a size of less than 50 μm or a size ranging from 0.05 to 50 μm or a size of less than 10 μm, preferably less than 5 μm or less than 2 μm, more preferentially less than 1 μm or less than 0.5 μm. Also preferably for suspension S according to the invention, material M is wet-ground in the presence of the aqueous dispersion. Preferably, the particles of ground material M thus have a size of less than 50 μm or a size ranging from 0.05 to 50 μm or a size of less than 10 μm, preferably less than 5 μm or less than 2 μm, more preferentially less than 1 μm or less than 0.5 μm.

Preferably according to the invention, the Brookfield viscosity of suspension S, measured after preparation at 100 rpm and at 25° C., is less than 1,000 mPa·s, preferably less than 800 mPa·s, more preferentially less than 600 mPa·s. Also preferably according to the invention, the Brookfield viscosity of suspension S, measured at 100 rpm and at 25° C. after being left to rest for 8 days at 25° C. and stirring at 100 rpm, is less than 1,000 mPa·s, preferably less than 800 mPa·s, more preferentially less than 500 mPa·s or less than 400 mPa·s.

Preferably, suspension S uses a single material M or two or three materials M. More preferably, suspension S uses a single material M. According to the invention, material M is synthetic or of natural origin. Preferably, material M is chosen among alkaline-earth metal carbonate, more preferentially calcium carbonate (natural calcium carbonate or precipitated calcium carbonate), strontium carbonate, magnesium carbonate, barium carbonate, dolomite, kaolin, titanium dioxide, talc, lime, calcium sulphate, barium sulphate. Preferably, material M is chosen among natural calcium carbonate, precipitated calcium carbonate, magnesium carbonate, dolomite, kaolin, titanium dioxide, talc, lime.

Preferably according to the invention, the solids content of suspension S is greater than 60% by weight, preferably greater than 70% by weight or greater than 75% by weight. Also preferably according to the invention, the solids content of suspension S is comprised between 60% by weight and 80% by weight, preferably between 70% by weight and 80% by weight or between 75% by weight and 80% by weight. The solids content of the suspension is measured by weighing an amount of 100 g of suspension from which the water and the volatile substances at room temperature are separated, for example by heating.

Essentially according to the invention, suspension S is prepared in the presence of an aqueous dispersion that comprises the α-sulphonated polymer P. Preferably according to the invention, polymer P is chosen among an α-ω-disulphonated polymer P1, an α-monosulphonated polymer P2 and combinations thereof.

Preferably according to the invention, polymer P is used in an amount by dry weight ranging from 0.02% by weight to 5% by weight, preferably from 0.05% by weight to 2% by weight, more preferentially from 0.1% by weight to 1.5% by weight relative to the amount by dry weight of mineral material M.

According to the invention, polymer P is prepared using monomer A. Preferably, monomer A is chosen among acrylic acid, an acrylic acid salt and combinations thereof. Advantageously, monomer A can be combined with at least one other monomer chosen among vinyl acetate, methyl acrylate, ethyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid and combinations thereof. More advantageously, monomer A is chosen among acrylic acid, an acid salt and combinations thereof, combined with at least one other monomer chosen among vinyl acetate, methyl acrylate, ethyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid and combinations thereof. Much more advantageously, monomer A can be combined with another monomer that is different from maleic acid and from maleic anhydride.

Essentially according to the invention, polymer P is prepared in the presence of at least one compound T comprising sulphur IV. Preferably, the compound T is chosen among lithium hydrogen sulphite, sodium hydrogen sulphite, potassium hydrogen sulphite, ammonium hydrogen sulphite, calcium di(hydrogen sulphite), magnesium di(hydrogen sulphite) and combinations thereof. Preferentially according to the invention, the compound T is a mono-hydrogen sulphite. Sodium hydrogen sulphite or sodium bisulphite is more particularly preferred.

Preferably according to the invention, the polymerisation reaction is carried out at a temperature above 30° C. and below: 100° C., preferably below 90° C., more preferentially below 80° C. or below 75° C.

According to the invention, polymer A is prepared in the presence of at least one initiator compound. Preferably, the initiator compound is chosen among a peroxide (for example hydrogen peroxide, tert-butyl hydroperoxide), a persulphate (for example sodium persulphate, ammonium persulphate, potassium persulphate), combinations thereof and associations thereof with a metal salt, preferably a metal salt chosen among an iron salt (for example Fe II or Fe III), a copper salt (for example Cu I or Cu II) and combinations thereof.

Essentially according to the invention, polymer P is partially or completely neutralised by means of a combination of at least one monovalent ion and of at least one divalent ion. According to the invention, the carboxyl groups of polymer P can be partially neutralised at a rate of 70 to 97 mol %, preferably at a rate of 90 to 95 mol %. Preferably, polymer P is completely neutralised.

According to the invention, polymer P can be completely or partially neutralised in variable relative molar proportions of monovalent and divalent ions. Preferably according to the invention, the monovalent ion/divalent ion molar proportions are comprised between 90/10 and 10/90 or between 80/20 and 20/80, preferably between 80/20 and 60/40, for example 70/30 or 50/50.

Preferably according to the invention, the monovalent ion is chosen among K⁺, Na⁺, Li⁺, NH₄⁺ and combinations thereof. The particularly preferred ion is Na⁺. According to the invention, polymer P can be neutralised by means of at least one compound chosen among NaOH, KOH, LiOH and ammonium derivatives. Also preferably according to the invention, the divalent ion is chosen among Ca²⁺, Mg²⁺ and combinations thereof. The particularly preferred ion is Ca²⁻. According to the invention, polymer P can be neutralised by means of at least one compound chosen among CaO, Ca(OH)₂, MgO, Mg(OH)₂ and combinations thereof.

Preferably, polymer P has a weight-average molecular mass Mw (measured by SEC) of less than 20,000 g/mol, preferably less than 15,000 g/mol, less than 10,000 g/mol, more preferentially less than 7,000 g/mol or less than 6,000 g/mol. Polymer P generally has a weight-average molecular mass Mw (measured by SEC) greater than 1,000 g/mol or greater than 1,200 g/mol.

Preferably, polymer P has a polymolecularity index PI (measured by SEC) of less than 4 or ranging from 1.2 to 4 or from 1.5 to 4: from 1.2 to 3 or from 1.5 to 3: from 1.2 to 2.5 or even from 1.5 to 2.5.

According to the invention, the molecular weight or mass of polymer P is determined by Size Exclusion Chromatography (SEC). A test portion of the polymer dispersion corresponding to 90 mg of dry solids content is placed in a 10 mL flask. Mobile phase is added, together with 0.04% dimethylformamide (DMF), until a total mass of 10 g is reached. The composition of this mobile phase is as follows: NaHCO₃:0.05 mol/L, NaNO₃:0.1 mol/L, triethanolamine: 0.02 mol/L, NaN₃ 0.03% by mass. The SEC chain is composed of a Waters 510 isocratic pump with a flow rate set to 0.8 mL/min, a Waters 717+ sample changer, an oven containing a Waters Ultrahydrogel Column Guard precolumn 6 cm long and 40 mm in inner diameter, followed by a Waters Ultrahydrogel linear column 30 cm long and 7.8 mm in inner diameter. Detection is provided by means of a Waters 410 RI differential refractometer. The oven is brought to a temperature of 60° C. and the refractometer is brought to a temperature of 45° C. The SEC instrument is calibrated with a series of polyacrylate sodium standards supplied by Polymer Standard Service with a molecular weight at the top of the peak comprised between 900 and 2,250,000 g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using PSS WinGPC Scientific software v 4.02. The chromatogram obtained is incorporated into the zone corresponding to molecular weights of more than 250 g/mol.

Preferably according to the invention, the molar amount of sulphur compound T within suspension S, preferably the molar amount of sulphur IV, is comprised between 1% and 15%, preferably between 1.5% and 12%, relative to the total molar amount of monomers used. More preferably according to the invention, the molar amount of sulphur compound T within suspension S, preferably the molar amount of sulphur IV, is comprised between 1% and 15%, preferably between 1.5% and 12%, relative to the total molar amount of unsaturated groups in the monomers used.

According to the invention, suspension S comprises at least one compound B chosen among a sulpho-carboxylic acid, a sulpho-carboxylic acid salt and combinations thereof.

According to the invention, compound B is chosen among sulpho-carboxy-aromatic acids and sulpho-carboxy-alkyl acids, particularly 3-sulphopropionic acid, 3-sulpho-2-methyl-propionic acid, sulpho-succinic acid, their salts and combinations thereof. The salts of compound B are generally sodium salt, potassium salt, lithium salt, calcium salt, magnesium salt or ammonium salt.

Essentially according to the invention, the molar amount of compound B present within suspension S is less than 25% relative to the molar amount of sulphur IV. Preferably, the molar amount of compound B is less than 20% or more preferentially less than 15% or less than 12% relative to the molar amount of sulphur IV. Generally according to the invention, the molar amount of compound B present within suspension S is greater than 0.2% relative to the molar amount of sulphur IV. In particular, the molar amount of compound B is greater than 2% or greater than 5% relative to the molar amount of sulphur IV. According to the invention, the molar amount of compound B present within suspension S relative to the molar amount of sulphur IV is therefore generally comprised within the ranges of from 0.2% to 25%, from 2% to 25%, from 5% to 25%, from 0.2% to 20%, from 2% to 20%, from 5% to 20%, from 0.2% to 15%, from 2% to 15%, from 5% to 15%, from 0.2% to 12%, from 2% to 12%, from 5% to 12%.

According to the invention, polymer P is prepared in the absence of any phosphorus compound. In particular, polymer P is prepared in the absence of any compound comprising phosphorus in oxidation state I, in particular in the absence of hypophosphorous acid, sodium hypophosphite, potassium hypophosphite, lithium hypophosphite, ammonium hypophosphite, calcium hypophosphite and magnesium hypophosphite: or in the absence of any compound comprising phosphorus in oxidation state III, in particular in the absence of phosphorous acid and of phosphorous acid salt.

The invention also relates to the preparation of suspension S. Thus, the invention relates to a method for preparing an aqueous suspension S comprising wet grinding at least one mineral material M in the presence of an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised solely by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV.

The preparation of suspension S according to the invention uses the aqueous dispersion of the α-sulphonated polymer P as an agent for grinding the mineral material M. The invention also relates to this agent. Thus, the invention provides a grinding agent comprising an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised solely by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV.

This agent makes it possible to improve the grinding of mineral material M in a particularly effective manner. Thus, the invention also provides a method for improving the efficacy of the wet grinding of at least one mineral material M comprising the use, while grinding, of an aqueous dispersion comprising at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised solely by means of a combination of at least one monovalent ion and of at least one divalent ion, with a reduced level of compound B chosen among a sulpho-carboxylic acid, a sulpho-carboxylic acid salt and combinations thereof, preferably comprising compound B in a molar amount of less than 25% relative to the molar amount of sulphur IV.

The aqueous suspension S obtained from the invention has particularly advantageous properties and can be used in many technical fields, in particular for paper preparation. Thus, the invention provides a method for preparing a mass filler composition for papermaking or a paper coating colour composition comprising the preparation of an aqueous suspension S of mineral particles prepared by wet grinding at least one mineral material M in the presence of an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised solely by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV.

This method for preparing paper comprises the use of a suspension S according to the invention.

The aqueous suspension S obtained through the invention can also be used to prepare a coating composition, in particular a varnish or a paint. Thus, the invention provides a method for preparing a coating composition comprising:
the preparation of an aqueous suspension S of mineral particles prepared by wet grinding at least one mineral material M in the presence of an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV,
mixing suspension S with at least one binder compound, optionally with at least one rheology modifying compound and optionally with at least one organic or mineral pigment.

The coating composition according to the invention comprises:
an aqueous suspension S of mineral particles prepared by wet grinding at least one mineral material M in the presence of an aqueous dispersion comprising:
a) at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of a combination of at least one monovalent ion and of at least one divalent ion,
b) at least one compound B chosen among a sulpho-carboxylic acid, a sulpho-carboxylic acid salt and combinations thereof, present in a molar amount of less than 25% relative to the molar amount of sulphur IV,
at least one binder compound, optionally with at least one rheology modifying compound and optionally at least one organic or mineral pigment.

The invention also provides a method for preparing a coating comprising applying a coating composition according to the invention to a substrate.

According to the invention, the particular, advantageous or preferred characteristics of the suspension S according to the invention define methods for its preparation, methods which use it as well as grinding agents which are also particular, advantageous or preferred. The following examples illustrate the various aspects of the invention.

### PREPARATION AND CHARACTERISATION OF POLYMERS P ACCORDING TO THE INVENTION

### Preparation of Polymer P1 According to the Invention

In a 1 litre glass reactor equipped with a stirrer, a thermometer and a cooling system, a load comprised of 0.006 g of iron sulphate heptahydrate and 380 g of water is prepared at room temperature. While the temperature is rising, 3 loads to be introduced in parallel over three hours are prepared. In a first beaker 623.5 g of acrylic acid are introduced, in a second beaker 5.086 g of sodium persulphate and 46.6 g of water are introduced, and in a third beaker 122.86 g of a 40% by mass aqueous sodium bisulphite solution are introduced. After three hours of addition at 73° C., a clear dispersion of polymer P1 is obtained. This polymer is then neutralised by adding sodium hydroxide and lime in a molar ratio corresponding to a neutralisation of 50% of the acid groups by the sodium ion and of 50% of the acid groups by the calcium ion (pH=8.3). The concentration of dry solids content is 36.6%. Polymer P1 has an Mw of 4,430 g/mol and a PI of 2.2.

### Preparation of Polymer P2 According to the Invention

In a 1 litre glass reactor equipped with a stirrer, a thermometer and a cooling system, a load comprised of 0.006 g of iron sulphate heptahydrate and 380 g of water is prepared at room temperature. While the temperature is rising, 3 loads to be introduced in parallel over three hours are prepared. In a first beaker 623.5 g of acrylic acid are introduced, in a second beaker 5.086 g of sodium persulphate and 46.6 g of water are introduced, and in a third beaker 135.15 g of a 40% by mass aqueous sodium bisulphite solution are introduced.

After three hours of addition at 73° C., a clear dispersion of polymer P2 is obtained. This polymer is then neutralised by adding sodium hydroxide and lime in a molar ratio corresponding to a neutralisation of 50% of the acid groups by the sodium ion and of 50% of the acid groups by the calcium ion (pH=8.1). The concentration of dry solids content is 39.9%. Polymer P2 has an Mw of 4,135 g/mol and a PI of 2.2.

### Preparation of Polymer P3 According to the Invention

In a 1 litre glass reactor equipped with a stirrer, a thermometer and a cooling system, a load comprised of 0.006 g of iron sulphate heptahydrate and 380 g of water is prepared at room temperature. While the temperature is rising, 3 loads to be introduced in parallel over three hours are prepared. In a first beaker 623.5 g of acrylic acid are introduced, in a second beaker 5.34 g of sodium persulphate and 46.6 g of water are introduced, and in a third beaker 129 g of a 40% by mass aqueous sodium bisulphite solution are introduced. After three hours of addition at 73° C., a clear dispersion of polymer P3 is obtained. This polymer is then neutralised by adding sodium hydroxide and lime in a molar ratio corresponding to a neutralisation of 50% of the acid groups by the sodium ion and of 50% of the acid groups by the calcium ion (pH=8.8). The concentration of dry solids content is 39.2%. Polymer P3 has an Mw of 4,405 g/mol and a PI of 2.2.

### Preparation of Polymer P4 According to the Invention

In a 1 litre glass reactor equipped with a stirrer, a thermometer and a cooling system, a load comprised of 0.006 g of iron sulphate heptahydrate and 380 g of water is prepared at room temperature. While the temperature is rising, 3 loads to be introduced in parallel over three hours are prepared. In a first beaker 623.5 g of acrylic acid are introduced, in a second beaker 5.595 g of sodium persulphate and 46.6 g of water are introduced, and in a third beaker 135.15 g of a 40% by mass aqueous sodium bisulphite solution are introduced. After three hours of addition at 73° C., a clear dispersion of polymer P4 is obtained. This polymer is then neutralised by adding sodium hydroxide and lime in a molar ratio corresponding to a neutralisation of 50% of the acid groups by the sodium ion and of 50% of the acid groups by the calcium ion (pH=8.6). The concentration of dry solids content is 39.2%. Polymer P4 has an Mw of 4,220 g/mol and a PI of 2.2.

### Preparation of Polymer P5 According to the Invention

In a 1 litre glass reactor equipped with a stirrer, a thermometer and a cooling system, a load comprised of 0.006 g of iron sulphate heptahydrate and 380 g of water is prepared at room temperature. While the temperature is rising, 3 loads to be introduced in parallel over three hours are prepared. In a first beaker 623.5 g of acrylic acid are introduced, in a second beaker 6.434 g of sodium persulphate and 46.6 g of water are introduced, and in a third beaker 155.43 g of a 40% by mass aqueous sodium bisulphite solution are introduced. After three hours of addition at 73° C., a clear dispersion of polymer P5 is obtained. This polymer is then neutralised by adding sodium hydroxide and lime in a molar ratio corresponding to a neutralisation of 50% of the acid groups by the sodium ion and of 50% of the acid groups by the calcium ion (pH=8.6). The concentration of dry solids content is 39.0%. Polymer P5 has an Mw of 3,720 g/mol and a PI of 2.1.

### Preparation of Polymer P6 According to the Invention

In a 1 litre glass reactor equipped with a stirrer, a thermometer and a cooling system, a load comprised of 0.006 g of iron sulphate heptahydrate and 380 g of water is prepared at room temperature. While the temperature is rising, 3 loads to be introduced in parallel over three hours are prepared. In a first beaker 623.5 g of acrylic acid are introduced, in a second beaker 7.02 g of sodium persulphate and 46.6 g of water are introduced, and in a third beaker 169.56 g of a 40% by mass aqueous sodium bisulphite solution are introduced. After three hours of addition at 73° C., a clear dispersion of polymer P6 is obtained. This polymer is then neutralised by adding sodium hydroxide and lime in a molar ratio corresponding to a neutralisation of 50% of the acid groups by the sodium ion and of 50% of the acid groups by the calcium ion (pH=8.0). The concentration of dry solids content is 40.2%. Polymer P6 has an Mw of 3,370 g/mol and a PI of 2.1.

### Preparation of Polymer P7 According to the Invention

In a 1 litre glass reactor equipped with a stirrer, a thermometer and a cooling system, a load comprised of 0.006 g of iron sulphate heptahydrate and 380 g of water is prepared at room temperature. While the temperature is rising, 3 loads to be introduced in parallel over three hours are prepared. In a first beaker 623.5 g of acrylic acid are introduced, in a second beaker 6.01 g of sodium persulphate and 46.6 g of water are introduced, and in a third beaker 145.3 g of a 40% by mass aqueous sodium bisulphite solution are introduced. After three hours of addition at 73° C., a clear dispersion of polymer P7 is obtained. This polymer is then neutralised by adding sodium hydroxide and lime in a molar ratio corresponding to a neutralisation of 50% of the acid groups by the sodium ion and of 50% of the acid groups by the calcium ion (pH=8.2). The concentration of dry solids content is 38.6%. Polymer P7 has an Mw of 3,820 g/mol and a PI of 2.1.

### Preparation of Polymer P8 According to the Invention

In a 1 litre glass reactor equipped with a stirrer, a thermometer and a cooling system, a load comprised of 0.006 g of iron sulphate heptahydrate and 380 g of water is prepared at room temperature. While the temperature is rising, 3 loads to be introduced in parallel over three hours are prepared. In a first beaker 623.5 g of acrylic acid are introduced, in a second beaker 6.01 g of sodium persulphate and 46.6 g of water are introduced, and in a third beaker 145.3 g of a 40% by mass aqueous sodium bisulphite solution are introduced. After three hours of addition at 73° C., a clear dispersion of polymer P8 is obtained. This polymer is then neutralised by adding sodium hydroxide and magnesia in a molar ratio corresponding to a neutralisation of 50% of the acid groups by the sodium ion and of 50% of the acid groups by the magnesium ion (pH=8.2). The concentration of dry solids content is 41.2%. Polymer P8 has an Mw of 3,820 g/mol and a PI of 2.1.

Compound B and the amount of compound B (mol % relative to the molar amount of sulphur IV of the compound T used) contained in each polymer dispersion are determined by sulphate ion assay and by ¹H NMR and ¹³C NMR analysis of the sulphonated groups of polymer P and of compound B.

The sulphate ion levels in the polymer dispersions are determined by ion chromatography. A test portion of about 80 mg of polymer dispersion is introduced into a 15 mL vial. Mobile phase is added to a total mass of 15 g. The composition of the mobile phase is as follows: sodium carbonate: 0.009 mol/L. The ion chromatography chain for the anion assay consists of a Dionex Aquion ion chromatography system with built-in degasser, of which the flow rate is set at 1 mL/min, containing a chemical suppressor, an AG9-HC precolumn, a CG3 metal trap precolumn, an NG1 precolumn and an AG9-HC column. A conductimetric detector is used for detection. The ion chromatography instrument is calibrated with a series of sodium sulphate solution standards. The calibration range is comprised between 0.5 and 100 ppm. The calibration curve is straight-line. The instrument automatically dilutes the samples to ensure that they are within the calibration range. Acquisition and processing of the chromatogram are performed using Chromeleon software 7.2.10.

¹H NMR and ¹³C NMR analyses are carried out using a Bruker AV III HD 500 spectrometer equipped with a 5 mm BBI probe. The polymer samples were dissolved in deuterated water and examined by ¹H NMR and ¹³C NMR using 2D experiments: correlations ¹H/¹³C at ordinary distance and at long distance.

The dispersions of polymers P1 to P8 according to the invention comprise 3-sulphopropionic acid as compound B. The results are shown in Table 1.

TABLE 1

| Polymer | P1 | P2 | P3 | P4 | P5 | P6 | P7 | P8 |
|---|---|---|---|---|---|---|---|---|
| Compound B (%) | 10.2 | 10.0 | 10.5 | 9.0 | 10.4 | 10.1 | 10.3 | 10.5 |

### Preparation and Characterisation of Aqueous Suspensions S According to the Invention

Using a peristaltic pump, a mineral suspension (calcium carbonate OM 10 AV—Omya) is prepared in the presence of a polymer P according to the invention using a grinder (Dyno Mill type KDL pilot 1.4 L) containing 2,750 g of ceramic beads (ER 120 S from 0.6 mm to 1.0 mm in diameter-Saint Gobain).

The grinding conditions are adjusted so as to obtain a suspension of particles of mineral material of the desired particle size distribution. The concentration of the suspension to be ground is 76%±1%. The amount of polymer introduced into the system is 1.02% by weight (dry polymer/dry calcium carbonate) in order to achieve the desired particle size distribution (80%±2% of particles<1 μm). This suspension is then characterised by a particle size measurement, by a Brookfield viscosity measurement (10 rpm and 100 rpm) and by a stability test.

The stability test consists of measuring the Brookfield viscosity of the ground suspension after a rest time of 8 days at a temperature of 25° C.±1° C., before stirring (at 100 rpm) and after stirring (at 10 rpm and 100 rpm). The particle size characteristics are determined using a SediGraph III5120 instrument (Micromeritics, USA).

The particle size distribution of the suspensions of mineral particles is measured by determining the mass fraction in percentage of a population of particles with an equivalent spherical diameter of less than 1 μm or even less than 2 μm (esd<1 μm or esd<2 μm, expressed in %). These measurements are carried out for an aqueous suspension of particles of mineral material diluted to a concentration of approximately 33 g of dry solids content per litre of solution and comprising an aqueous dispersion of polymer P at a concentration of 1.6 g of dry polymer. Each sample is dispersed and sonicated prior to measuring.

The Brookfield viscosities at 10 rpm and 100 rpm (mPa·s) of aqueous suspensions of particles of mineral material are measured at 25° C.±2° C. after grinding (VB0) and after 8 days of rest (at 25° C.±2° C.) (VB8) then after 8 days and after stirring (VB8a), at 25° C.±1° C. using a Brookfield DVIII viscometer equipped with a suitable module 2 to 5.

The polymers used and the results obtained are shown in Table 2.

TABLE 2

| Polymer | P1 | P2 | P3 | P4 | P5 | P6 | P7 | P8 |
|---|---|---|---|---|---|---|---|---|
| esd <1 μm (%) | 80 | 80 | 80 | 80 | 80 | 80 | 80 | 80 |
| esd <2 μm (%) | 98 | 98 | 98 | 98 | 98 | 98 | 98 | 98 |
| VB0 10 rpm | 1,630 | 1,380 | 1,300 | 1,570 | 800 | 1,200 | 950 | 900 |
| VB0 100 rpm | 483 | 416 | 398 | 475 | 235 | 360 | 286 | 266 |
| VB8 100 rpm | 2,000 | 2,080 | 1,369 | 1,876 | 960 | 2,140 | 1,024 | 1,060 |
| VB8a 10 rpm | 1,190 | 1,160 | 930 | 1,080 | 760 | 1,230 | 964 | 840 |
| VB8a 100 rpm | 369 | 358 | 280 | 335 | 240 | 358 | 300 | 260 |

The use of a polymer P according to the invention comprising a controlled amount of compound B makes it possible to effectively control the particle size of the suspension as well as its viscosity and its stability.

1. An aqueous suspension S, comprising: of
mineral particles prepared by wet grinding at least one mineral material M in the presence of an aqueous dispersion comprising:
(a) an α-sulfonated polymer P prepared in water and in the absence of any phosphorus compound, by a polymerization of a monomer A comprising acrylic acid, methacrylic acid, an acrylic acid salt, and/or a methacrylic acid salt, in the presence of an auxiliary comprising an initiator compound and a sulfur compound T comprising sulfur in oxidation state IV, and at least partially neutralized by a combination comprising a monovalent ion and a divalent ion; and
(b) a compound B comprising a sulfo-carboxylic acid and/or a sulfo-carboxylic acid salt, present in a molar amount of less than 25%, relative to a molar amount of sulfur IV.

2. The suspension S of claim 1, wherein
particles of ground mineral material M have a size of less than 50 μm.

3. The suspension S of claim 1, wherein
a single material M is used.

4. The suspension S of claim 1, wherein the α-sulfonated polymer P comprises α-ω-disulfonated polymer P1 and/or an α-monosulfonated polymer P2.

5. The suspension S of claim 1, wherein:
the monomer A comprises acrylic acid and/or an acrylic acid salt, or
the monomer A further comprises vinyl acetate, ethyl acrylate, methyl acrylate, hydroxyethylmethacrylate, hydroxyethylacrylate, hydroxypropylmethacrylate, hydroxypropylacrylate, 2-acrylamido-2-methylpropane sulfonic acid, maleic acid, maleic anhydride, and/or itaconic acid, or
the monomer A comprises acrylic acid and/or an acid salt, and further comprises 2-acrylamido-2-methylpropane sulphonic acid (AMPS), maleic acid, maleic anhydride, and/or itaconic acid, or
the sulfur compound T comprises lithium hydrogen sulfite, sodium hydrogen sulfite, potassium hydrogen sulfite, ammonium hydrogen sulfite, calcium di(hydrogen sulfite), and/or magnesium di(hydrogen sulfite), or
the polymerization is carried out at a temperature above 30° C. and below 100° C., or the initiator compound comprises a peroxide and/or a persulfate, optionally associated with a metal salt, or
the polymer P is at least partially non-neutralized, or
the monovalent ion comprises K⁺, Na⁺, Li⁺, and/or NH₄⁺ and the divalent ion comprises Mg²⁺ and/or Ca²⁺, or
the polymer P has a weight-average molecular mass MW measured by SEC less than 20,000 g/mol, or
the polymer I has a weight-average molecular mass Mw (measured by SEC) greater than 1,000 g/mol, or
the polymer P has a polymolecularity index PI (measured by SEC) of less than 4, or
the polymer P is used in an amount by dry weight in a range of from 0.02 to 5 wt. %, relative to a dry weight of the mineral material M.

6. The suspension S of claim 1, wherein
a molar amount of sulfur compound T is in a range of from 1 to 15%.

7. The suspension S of claim 1, wherein the compound B comprises a sulfo-carboxy-aromatic acid and/or a sulfo-carboxy-alkyl acid.

8. The suspension S of claim 1, wherein a
molar amount of compound B is less than 20%, relative to a molar amount of sulfur IV, or
wherein a molar amount of the compound B present within suspension S is greater than 0.2%, relative to a molar amount of sulfur IV.

9. A method for preparing the aqueous suspension S of claim 1, the method comprising:
wet grinding the at least one mineral material M in the presence of the aqueous dispersion.

10. A grinding agent, comprising an aqueous dispersion comprising:
(a) an α-sulfonated polymer P prepared in water and in the absence of any phosphorus compound, by a polymerization of a monomer A comprising acrylic acid, methacrylic acid, an acrylic acid salt, and/or a methacrylic acid salt, in the presence of an auxiliary comprising an initiator compound and a sulfur compound T comprising sulfur in oxidation state IV, and at least partially neutralized by a combination comprising a monovalent ion and a divalent ion; and
(b) a compound B comprising a sulfo-carboxylic acid and/or a sulfo-carboxylic acid salt, present in a molar amount of less than 25%, relative to a molar amount of sulfur IV.

11. A method for improving efficacy of wet grinding of at least one mineral material M, the method comprising:
contacting, while grinding, an aqueous dispersion comprising an α-sulfonated polymer P prepared in water and in the absence of any phosphorus compound, by a polymerization of a monomer A comprising acrylic acid, methacrylic acid, an acrylic acid salt, and/or a methacrylic acid salt, in the presence of an auxiliary comprising initiator compound and a sulfur compound T comprising sulfur in oxidation state IV; and
at least partially neutralizing the polymer P by a combination comprising a monovalent ion and a divalent ion, with a reduced level of compound B comprising a sulfo-carboxylic acid and/or a sulfo-carboxylic acid salt.

12. A method for preparing a mass filler composition for papermaking or a paper coating color composition, the method comprising:
preparing the aqueous suspension S of claim 1.

13. A method for preparing paper, the method comprising:
contacting the suspension S of claim 1 and a paper precursor.

14. A method for preparing a coating composition, the method comprising:
preparing the aqueous suspension S of claim 1; and
mixing the aqueous suspension S with at least one binder compound, optionally with at least one rheology modifying compound and optionally with at least one organic or mineral pigment.

15. A coating composition, comprising:
the aqueous suspension S of of claim 1; and
a binder compound; and
optionally, a rheology modifying compound; and
optionally, an organic or mineral pigment.

16. A method for preparing a coating, the method comprising:
applying the coating composition of claim 15 to a substrate.

17. The suspension S of claim 1, wherein particles of ground mineral material M have a size in a range of from 0.05 to 50 μm.

18. The suspension S of claim 1, having a Brookfield viscosity, measured after preparation and at 100 rpm and at 25° C., of less than 1,000 mPa·s.

19. The suspension S of claim 1, having a Brookfield viscosity, measured at 100 rpm at 25° C. after resting for 8 days at 25° C. and stirring at 100 rpm, of less than 1,000 mPa·s.

20. The suspension S of claim 1, having a solids content greater than 60 wt. %.
